(19) United States
(12) Patent Application Publication
(10) Pub. No.: US 2011/0220450 A1
(43) Pub. Date: Sep. 15, 2011

(54) HUB RATCHET DRIVING DEVICE FOR BICYCLES

(75) Inventor: PI-YUN CHIANG, TAICHUNG HSIEN (TW)

(73) Assignee: JOY INDUSTRIAL CO., LTD., TAICHUNG HSIEN (TW)

(21) Appl. No.: 12/720,215

(22) Filed: Mar. 9, 2010

(51) Int. Cl. F16D 23/00

(52) U.S. Cl. 192/64

(57) ABSTRACT

A hub ratchet driving assembly includes a hub and a driving member is connected to an end of the hub. The driving member includes a driving portion which has first and second recesses defined in an outer surface thereof so as to receive a pawl and a spring member therein. A teeth ring is connected to the hub and includes multiple teeth in an inner periphery thereof. The spring member biases the pawl so as to provide a return force to the pawl. The pawl includes two ratchet teeth which are engaged with the teeth of the teeth ring. A positioning unit has a first positioning slot defined in the driving portion and a second positioning slot is defined in the pawl. A positioning ring is mounted to the first and second slots so as to prevent the pawl from disengaging from the driving portion in axial direction.

### FIELD OF THE INVENTION

The present invention relates to a ratchet mechanism, and more particularly, to a hub ratchet driving device for bicycles.

### BACKGROUND OF THE INVENTION

A conventional ratchet mechanism is used to drive object in one direction and generally includes a pawl which is the active member and a gear which is the passive member, the gear includes teeth which have two inclined surfaces so that the pawl can only firmly engage with the functional inclined surface and slip from the non-functional inclined surface. Therefore, when the pawl is engaged with the functional surface, the active member rotates with the passive member. When the pawl skips from the non-functional inclined surface, the active member cannot drive the passive member which is freely rotated

The ratchet mechanism is used on the hub wherein the driving member is connected to an end of the hub. The driving member is the active member and the hub is the passive member. There are three operation modes, the first one is that the driving member drives the hub to rotate in one direction so that the bicycle moves forward. The second is that the driving member is rotated in the opposite direction, the driving member cannot drive the hub, so that the hub and the driving member are disengaged from each other. The third is that the driving member drives the hub for a period of time and is then stopped, the hub is freely rotated forward so that the bicycle still moves forward.

There requires a spring unit to control the pawl to engage with the gear or not, the spring unit can be a single one which controls all of the pawls of the system. The spring unit can include multiple spring members which control the gears individually.

A conventional hub ratchet driving assembly includes a driving member connected to one end of the hub and the driving member includes three recesses defined in an inner periphery thereof. Three pawls are pivotably received in the three recesses. Each pawl includes a pivot which is engaged with a hole defined in each of the recesses. The pawl includes a groove defined in an outer surface thereof and a resilient ring is engaged with the groove. The hub includes a teeth ring which is cooperated with the three pawls. An axle rotatably extends through the hub and the driving member. The recesses ensure that the three pawls are not shifted during operation.

Another conventional hub ratchet driving assembly includes a hub having multiple axial grooves defined therein and multiple pawls are received in the axial grooves. Multiple resilient members are engaged with the axial grooves and bias the pawls toward the open end of the hub. A stop member includes a plate and multiple positioning protrusions which are inserted into positioning holes defined in the hub, so that the plate contacts against the inside of the hub so as to prevent the pawls and the resilient member from disengaged from the open end of the hub.

The present invention is focused on the improvement of the second conventional hub ratchet driving assembly which uses a stop member to prevent the pawls the resilient members from disengaging from the open end of the hub. Nevertheless, the protrusions are securely inserted into the positioning holes and this means that the assemblers have to insert the protrusions into the corresponding positioning holes one by one. This is difficult because the resilient members may deform and the pawls may not be located at the desired positions. Besides, when maintenance, all of the protrusions have to be removed from the positioning holes to maintain the parts, and after the maintenance is finished, all the protrusions are inserted into the positioning holes again.

### SUMMARY OF THE INVENTION

The present invention relates to a hub ratchet driving assembly and comprises a hub which is connected to a driving member. A driving portion is formed on one end of the driving member and has first and second recesses defined in an outer surface thereof. A ratchet unit has a teeth ring connected to an inside of the hub and the teeth ring includes multiple teeth defined in an inner periphery thereof. A pawl and a spring member are respectively received in the first and second recesses. The spring member biases the pawl so as to provide a return force to the pawl. A portion of the pawl that protrudes from the first recess includes two ratchet teeth which are engaged with the teeth of the teeth ring. A positioning unit has a first positioning slot defined in the driving portion and an end surface is located beside the pawl, the end surface and the pawl define a second positioning slot. A positioning ring is mounted to the first and second slots, one side of the positioning ring contacts the pawl so as to prevent the pawl from disengaging from the driving portion in axial direction.

The primary object of the present invention is to provide a hub ratchet driving assembly which includes simple structure and can be easily assembled.

Another object of the present invention is to provide a hub ratchet driving assembly wherein the positioning ring includes smaller contact area so that the pawl can be pivoted smoothly without interference. The pawl does not sifted or loose.

Yet another object of the present invention is to provide a hub ratchet driving assembly which combines the advantages of multiple resilient members and multiple ratchet teeth so that the present invention has better driving feature.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hub ratchet driving assembly of the present invention;

FIG. 2 is an exploded view to show the hub ratchet driving assembly of the present invention;

FIG. 3 is a cross sectional view of the hub ratchet driving assembly of the present invention;

FIG. 4 is a cross sectional view, taken alone line A-A in FIG. 3;

FIG. 5 shows that the driving portion drives the hub counter clockwise;

FIG. 6 shows that the driving portion rotates clockwise and cannot drive the hub, and

FIG. 7 is an exploded view to show another embodiment of the positioning ring.

### DETAILED DESCRIPTION OF THE PREFERRED EMBODIMENT

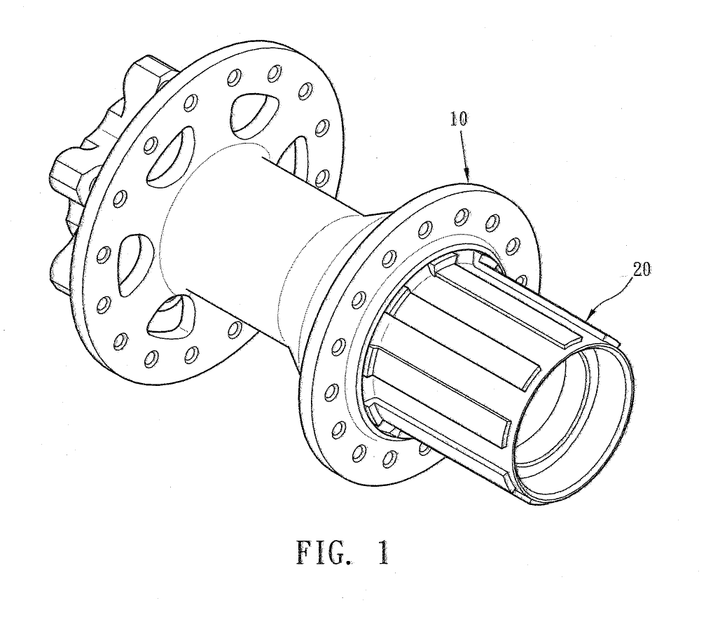

Referring to FIGS. 1 to 3, the hub ratchet driving assembly of the present invention comprises a hub 10, a driving member 20 connected to one end of the hub 10, a ratchet unit 30 located between the hub 10 and the driving member 20, and a positioning unit 40 cooperated with the ratchet unit 30.

The hub 10 is a hollow tube and includes a connection end 11 which includes threads defined in an inner periphery thereof.

The driving member 20 includes a driving portion 21 formed on one end of the driving member 20 and the driving portion 21 has first and second recesses 22, 23 integrally defined in an outer surface thereof.

The ratchet unit 30 has a teeth ring 31 which is threadedly connected to the connection end 11. The teeth ring 31 includes multiple teeth 311 defined in an inner periphery thereof. A pawl 32 and a spring member 33 are respectively received in the first and second recesses 22, 23. The spring member 33 biases the pawl 32 so as to provide a return force to the pawl 32. A portion of the pawl 32 protruding from the first recess 22 includes two ratchet teeth 321, 322 which are engaged with the teeth 311 of the teeth ring 31.

The positioning unit 40 has a first positioning slot 41 defined in the driving portion 21 and an end surface 42 is located beside the pawl 32. The end surface 42 and the pawl 32 define a second positioning slot 43. A positioning ring 44 is mounted to the first and second slots 41, 43. It is noted that the first and second positioning slots 41, 43 share a common axis so that the positioning ring 44 can be easily engaged with the first and second positioning slots 41, 43. One side of the positioning ring 44 contacts the pawl 32 so as to prevent the pawl 32 from disengaging from the driving portion 21 in axial direction. The first positioning slot 41 is located close to a distal end of the driving portion 21 and extends radially relative to the driving portion 21. The second positioning slot 43 is defined in the pawl 32 and located corresponding to the first positioning slot 41.

The driving portion 21 extends through the teeth ring 31 and the teeth 311 are engaged with both of the two ratchet teeth 321, 322. There are two ratchet teeth 321, 322 simultaneously engaged with the teeth 311 so that when the driving portion 21 drives the hub 10, the two ratchet teeth 321, 322 provide a stable and sufficient driving force to the hub 10.

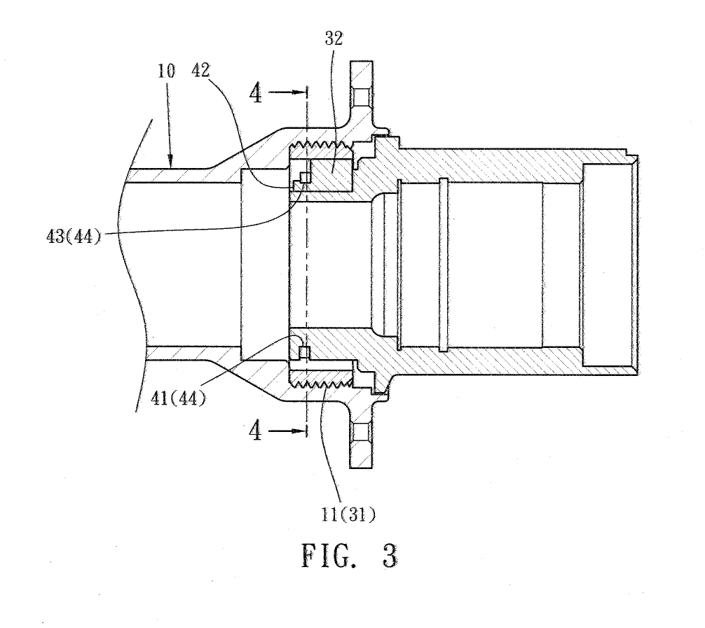

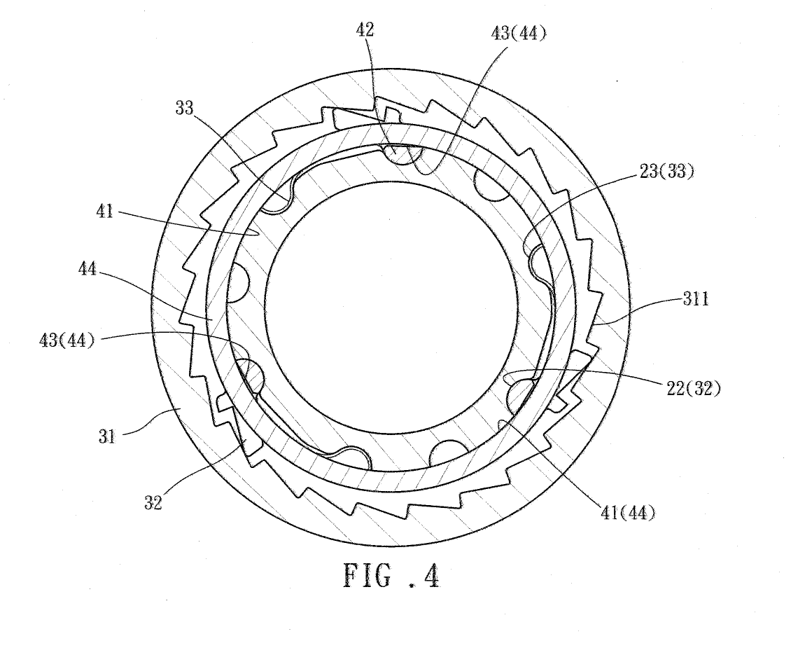

As shown in FIGS. 3 and 4, when the positioning ring 44 is engaged with the first and second positioning slots 41, 43, one side of the positioning ring 44 contacts the pawl 32 and the spring member 33 to prevent the pawl 32 and the spring member 33 from, disengaging from the hub 10, while the pawl 22 still works properly.

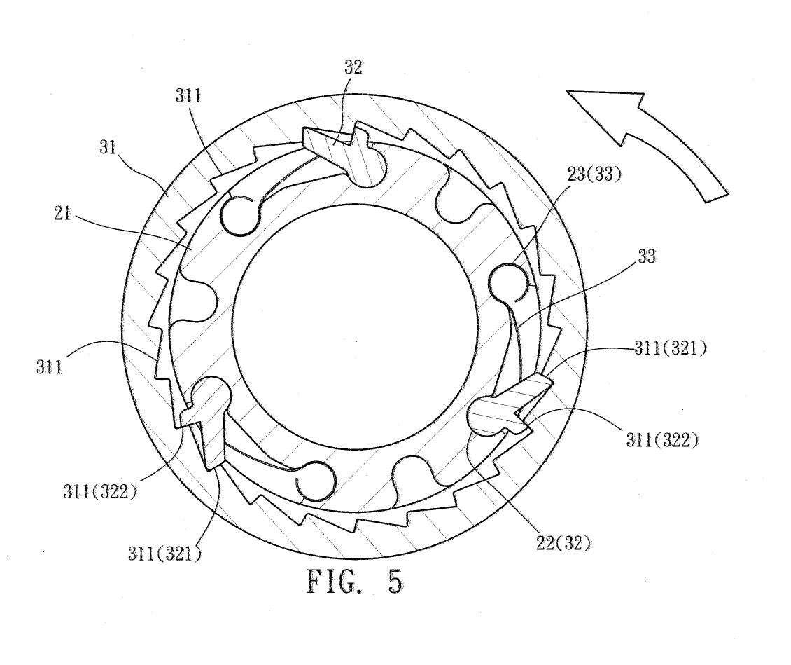

As shown in FIG. 5, when the two ratchet teeth 321, 322 rotate counter clockwise, the hub 10 is driven by the driving portion 21 so that the bicycle (not shown) moves forward.

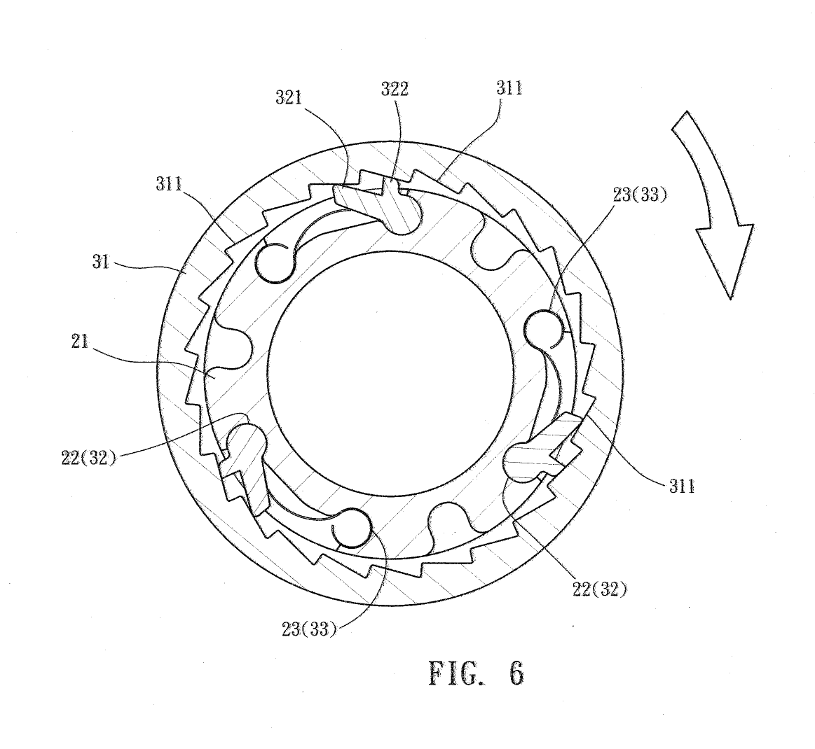

As shown in FIG. 6, when the two ratchet teeth 321, 322 rotate clockwise, the two ratchet teeth 321, 322 cannot engage the teeth 311 of the teeth ring 31 so that the hub 10 is not driven by the driving portion 21. If the bicycle is in stationary status, the clockwise rotation of the two ratchet teeth 321, 322 does not move the bicycle and the bicycle is not moves backward. If the driving portion 21 does not rotate and the hub 10 and the teeth ring 31 rotate counter clockwise, the two ratchet teeth 321, 322 slip from the teeth 311.

The end surface 42 and the second slot 43 are integrally formed on the pawl 32 so that the pawl 32 can be directly cooperated with the positioning ring 44 without any adjustment during assembling processes. The positioning ring 44 contacts the pawl 32 by a small area which allows the pawl 32 to be operated smoothly and the pawl 32 is not stocked easily.

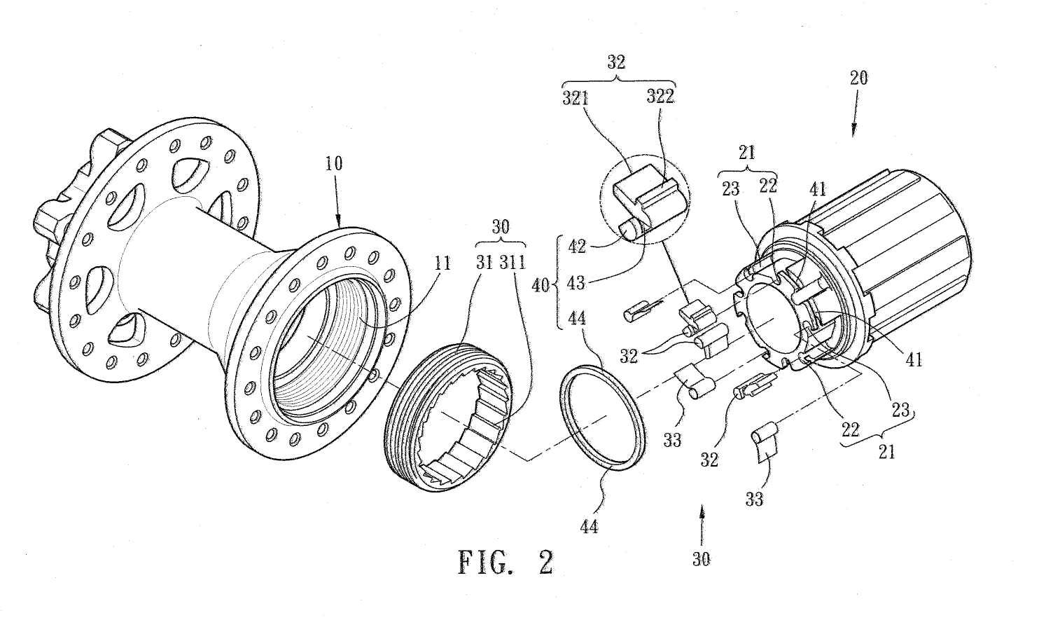

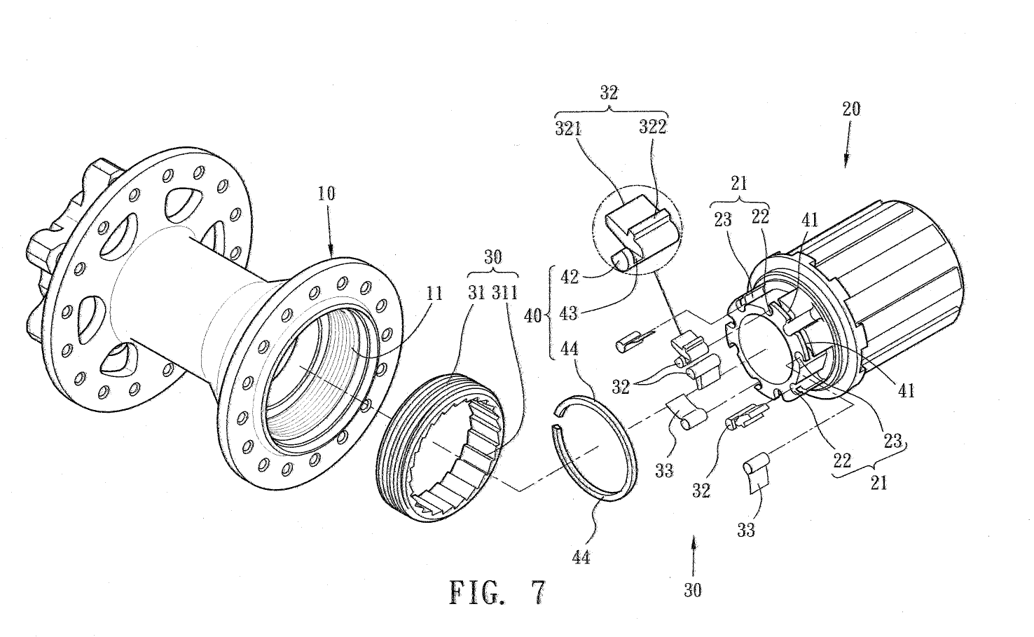

The positioning ring 44 is made of resilient material and can be a closed ring as shown in FIG. 2 or a C-shaped ring as shown in FIG. 7.

While we have shown and described the embodiment in accordance with the present invention, it should be clear to those skilled in the art that further embodiments may be made without departing from the scope of the present invention.

What is claimed is:

1. A hub ratchet driving assembly comprising:
a hub;
a driving member being a hollow tube and a driving portion formed on one end of the driving member, the driving portion having first and second recesses defined in an outer surface thereof;
a ratchet unit having a teeth ring connected to an inside of the hub and the teeth ring including multiple teeth defined in an inner periphery thereof, a pawl and a spring member respectively received in the first and second recesses, the spring member biasing the pawl so as to provide a return force to the pawl, a portion of the pawl protruding from the first recess and including two ratchet teeth which are engaged with the teeth of the teeth ring, and
a positioning unit having a first positioning slot defined in the driving portion and an end surface located beside the pawl, the end surface and the pawl define a second positioning slot, a positioning ring mounted to the first and second slots, one side of the positioning ring contacting the pawl so as to prevent the pawl from disengaging from the driving portion in axial direction.

2. The assembly as claimed in claim 1, wherein the first and second positioning slots share a common axis.

3. The assembly as claimed in claim 1, wherein the driving portion extends through the teeth ring and the teeth are engaged with both of the two ratchet teeth.

4. The assembly as claimed in claim 1, wherein the hub includes a connection end and the teeth ring is threadedly connected to the connection end, the driving portion, the first recess and the second recess are integrally formed as one piece.

5. The assembly as claimed in claim 1, wherein the positioning ring is a closed ring.

6. The assembly as claimed in claim 1, wherein the positioning ring C-shaped ring.

7. The assembly as claimed in claim 1, wherein the positioning ring is made of resilient material.

8. The assembly as claimed in claim 1, wherein the first positioning slot is located close to a distal end of the driving portion and extends radially relative to the driving portion, the second positioning slot is defined in the pawl and located corresponding to the first positioning slot.
